(19) United States
(12) Patent Application Publication
(10) Pub. No.: US 2008/0064442 A1
(43) Pub. Date: Mar. 13, 2008

(54) IDENTITY AND PAYMENT MODEM MODULE FOR HANDSETS

(75) Inventors: Russell Boltwood, Piedmont, CA (US); Charles MacKinnon, Northbrook, IL (US); John Fijolek, Naperville, IL (US)

Correspondence Address: FELIX L. FISCHER, ATTORNEY AT LAW, 1607 MISSION DRIVE, SUITE 204, SOLVANG, CA, 93463, US

(73) Assignee: UTSTARCOM, :INC., Alameda, CA (US)

(21) Appl. No.: 11/530,586

(22) Filed: Sep. 11, 2006

(51) Int. Cl. H04B 1/38; H04M 1/00

(52) U.S. Cl. 455/558

(57) ABSTRACT

A miniaturized form factor card provides a communications system for mobile information devices having an applications processor and user interface components. A receiving frame is provided in the mobile information device and an insertable miniaturized form factor card incorporating means for RF transmission and reception and a wireless modem and having an indexing connector which is received in a mating moiety in the receiving frame. The applications processor and the user interface components in the mobile information device are interconnected to digital functions of the wireless modem and means for RF transmission and reception through the connector. Additionally, the miniaturized form factor card further includes a power management function interfacing with the applications processor and user interface components through the connector.

### REFERENCE TO RELATED APPLICATIONS

This application is copending with U.S. patent application Ser. No. 11/308,221 filed on Mar. 13, 2006 entitled MINIATURIZED FORM FACTOR WIRELESS COMMUNICATIONS CARD FOR GENERIC MOBILE INFORMATION DEVICES, which is incorporated herein by reference in its entirety as though fully set forth.

### BACKGROUND OF THE INVENTION

1. Field of the Invention

This invention relates generally to the field of operating platforms for mobile phones and personal data systems and more particularly to a wireless communications card with a miniaturized form factor which is insertable into generic mobile information devices to accommodate desired wireless communication functions and provide personalized identification information and data for the user to be available in any of the generic mobile information devices in which the card is inserted.

2. Related Art

Electronic devices employed by consumers are increasing in diversity of applications; MP3 players, cellular phones, video and still cameras and PDAs. Each of these devices typically employs components that would be usable for other applications that currently require an alternative handset or device. Additionally, current design time-to-market for mobile phone and personal information devices is extended due to current design philosophy and practice. Turn-around time for a typical complete handset design is about 9 months. Where voice communication capability is desired, terminal vendors need to spend significant amount of resources on basic wireless communication functions and cannot concentrate on truly value-added design work, such as industrial design and software applications. It is also difficult to develop multiple models with significant differences based on a common printed circuit board (PCB) platform. Traditional wireless devices using discrete solution have difficulty supporting multiple band or modes such as GSM, CDMA, 3 G. Discrete chipset solutions consume at least three times more PCB space. There are significant financial and technical barriers of entry for new companies without significant resources, or established companies without wireless expertise.

Currently there are some vendors selling modules that can provide wireless communication functions in a particular wireless technology. However these modules are large in size with proprietary interfaces. These modules require significant amount of vendor integration. Alternatively, certain prior art systems are simply modularizing wireless modem functions. Prior art systems for removable cartridges providing communications elements such as that disclosed in U.S. Pat. No. 6,690,947 to Tom provide some flexibility in applications design; however, such systems were bulky and lacked packaging and connector innovations required for practical application of such systems.

Subscriber Information Modules (SIM) are employed with certain cellular phone technologies to allow a subscriber to use several different handsets with differing technologies. This system has been successfully employed to allow a single user to employ a GSM handset while in a service area with that technology available and a CDMA handset in a region or service area supporting that technology. However, the SIM capability is limited to user identification while the handsets must completely support their various technology applications.

Referenced copending U.S. patent application Ser. No. 11/308,221 provides a system that allows a single miniaturized form factor card to provide an entire communications and control suite that can be employed with various mobile information devices or handsets. This system provides the ability to integrate hardware, software, utilities and drivers which will allow true plug and play functionality for end users or mobile information device design houses. The desired functional capability is provided through an insertable card to eliminate the requirement for a separate CPU or applications processor in the mobile information device and additionally, provides a complete modem solution that will support multi-mode and multi-band communications.

In combination with the communications functions offered by a Miniaturized Form Factor Card which brings a variety of air interfaces to different devices (handset shells, cameras, PDAs) it is desirable to accommodate the different carrier requirements for the different air interfaces including a built-in prepaid module. It is further desirable that the prepaid module also have the capability to have more minutes added to extend its life. Additionally it is desirable that each new device not have to relearn address books and other associated information but that such information is added in a built-in user's identity. This identity desirably also provides secure access to users financial information. An additional desirable feature is that the module itself have the capability to be used to pay for goods. All of these characteristics can be transferred to the device using the module. It is desirable that the module itself be device-aware enough to adjust information formats accordingly.

### SUMMARY OF THE INVENTION

The present invention provides an insertable miniaturized form factor card removably received in a mobile information device. The card incorporates capability for RF transmission and reception and a wireless modem which is interfaced with user interface components of the mobile information device to interconnect digital functions of the wireless modem and means for RF transmission and reception through the interface. The card incorporates user identification and user specific data storage for use with the mobile information device or as an independent device with a simple receiver such as a key fob. The card is also independently receivable in properly equipped ATM servers or similar devices for direct use of the user identification and specific data storage.

### BRIEF DESCRIPTION OF THE DRAWINGS

These and other features and advantages of the present invention will be better understood by reference to the following detailed description when considered in connection with the accompanying drawings wherein:

FIG. 1 is an exploded view of a miniaturized form factor card employing the present invention and an exemplary mobile information device;

FIG. 2 is a block diagram of the elements of an exemplary embodiment of a miniaturized form factor card;

FIG. 3 is a block diagram of the interaction between an applications processor and other mobile information device functions with the elements of the miniaturized form factor card;

FIG. 4 is a block diagram of the functionality elements provided in the memory and processing capability of the present invention;

FIG. 5 is a block diagram of the user identification elements of an exemplary embodiment of the system;

FIG. 6 is a block diagram of the personal transportable data elements of an exemplary embodiment of the system;

FIG. 7 is a block diagram of the transportable applications of an exemplary embodiment of the system;

FIG. 8 is a representation of a key fob receiver for the card independent of a mobile information device;

FIG. 9 is a representation of an ATM server attachment arrangement for the card independent of a mobile information device; and,

FIG. 10 is a schematic representation of the various mobile information devices for which the miniaturized form factor card employing the present invention would be applicable.

### DETAILED DESCRIPTION OF THE INVENTION

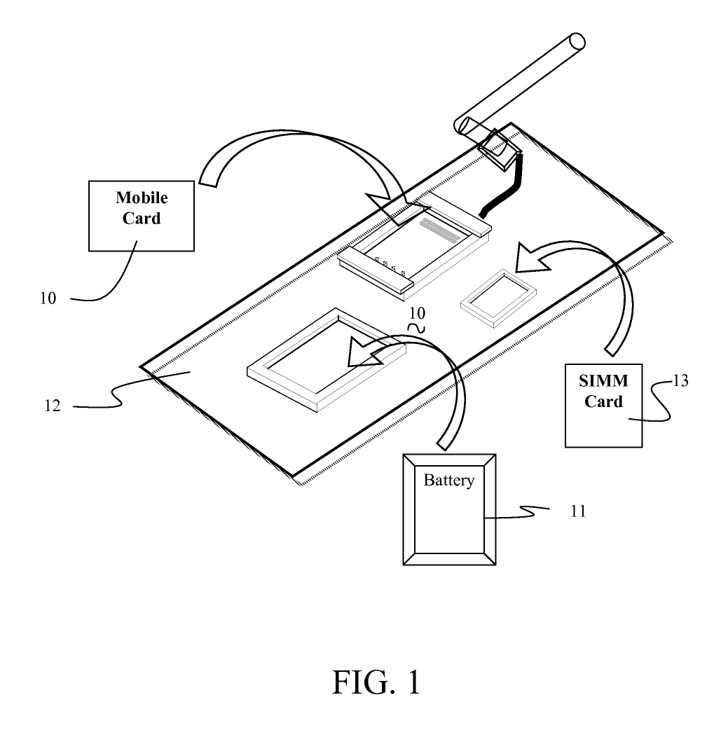

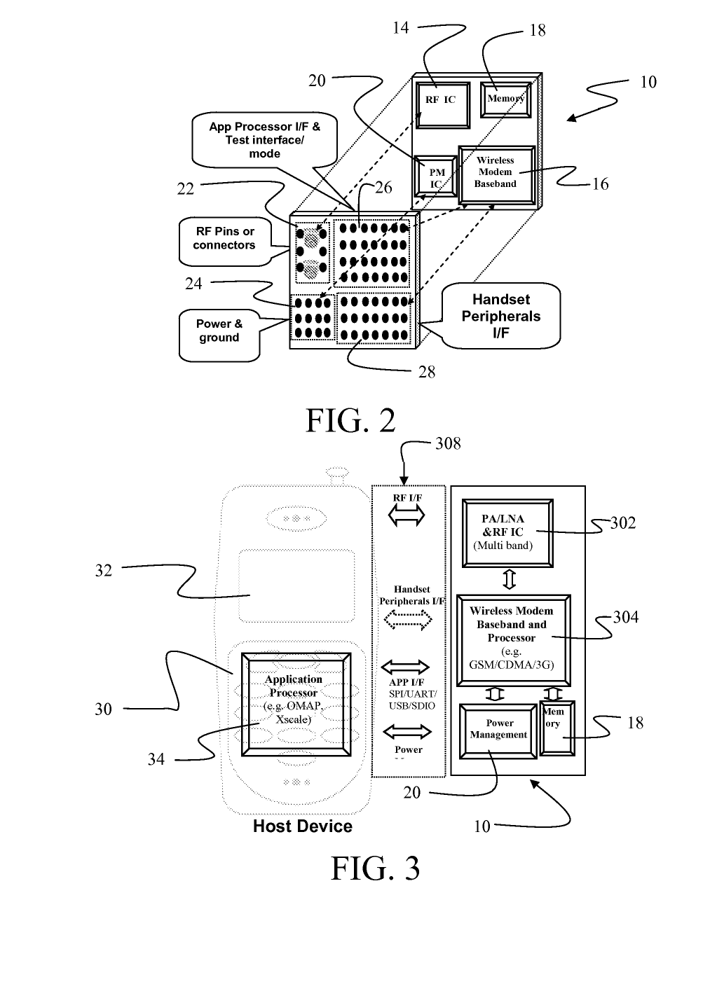

FIG. 1 demonstrates one embodiment of the present invention with a miniaturized form factor card 10 according to the invention shown exploded from the mobile information device printed circuit board 12 in which it is to be installed. Battery and single inline memory module (SIMM) card elements are also shown for reference. In certain embodiments, For the drawing, a mobile phone is shown as the mobile information device (MID) however, the invention described herein is applicable to other MIDs such as cameras, PDAs, MP3 players, etc. FIG. 2 shows an exemplary block diagram of the functional elements of the card of FIG. 1. In an exemplary embodiment, the form factor of the card is comparable to a secure digital (SD) card having a substantially rectangular dimensional planform of about 24 by 32 mm with a thickness of about 2-3 mm. The communications elements included in the card are an RF integrated circuit 14, a wireless baseband modem 16, a memory 18 for use by the processing elements of the modem and RF circuits and a power management integrated circuit 20. An exemplary pin layout for a bump technology interface integrated into the bottom of the card provides connection elements 22 for the RF circuit, a connection block for the power and ground requirements 24, a set of connector elements interface with the applications processor 26 including a test interface and a set of connector elements to interface with the handset peripherals 28 including the keypad 30, display 32 and other basic handset functions for user interface.

The miniaturized form factor card provides all of the elements for a desired communication technology such as PHS, CDMA, GSM, WiMax, wireless LAN or UMTS, including single or multiband. The technology can be included as single or multiple mode technologies in certain applications. The handset design can then concentrate on the human factor interface elements and the functions desired for the device which are not related to communications or user identity specific data. As shown in FIG. 3, an applications processor 34 for the mobile information device such as those produced by Texas Instruments, Inc. or Intel, Inc. or other manufacturers provides the desired functionality of the mobile information device and interface with the elements of card 10 for communications enablement. For the embodiment shown, a Power Amplifier/Low Noise Amplifier PA/LNA and RF circuit 302 is provided for a multiband communications protocol with associated modem 304. Communication with the peripherals and applications is provided through interface 308 through SPI, UART, USB, and/or SDIO. In certain applications, the base band processor in the modem in the card allows elimination of a separate CPU or applications processor in the mobile information device. In such embodiments, the processing capability is provided entirely within the miniaturized form factor card.

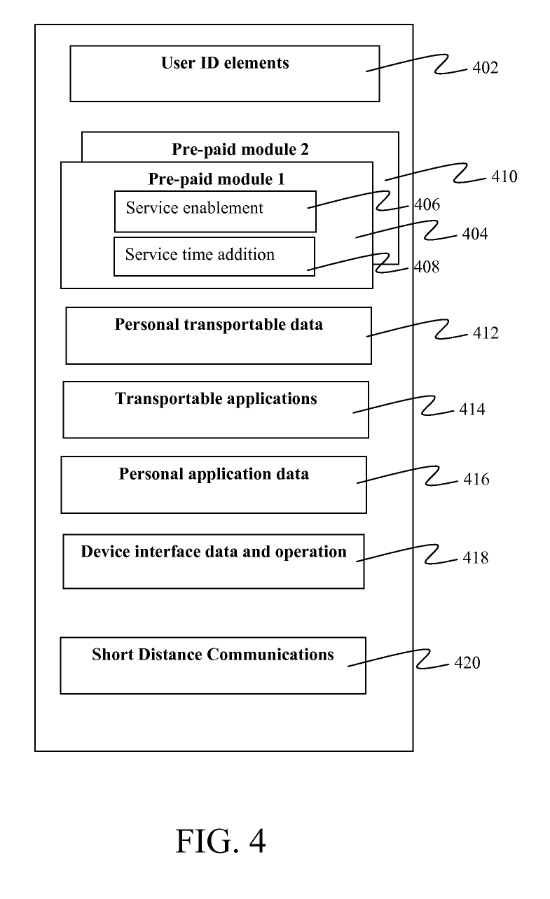

FIG. 4 provides a block diagram of the functionality elements of the present invention provided using the memory and processing capability within the card.

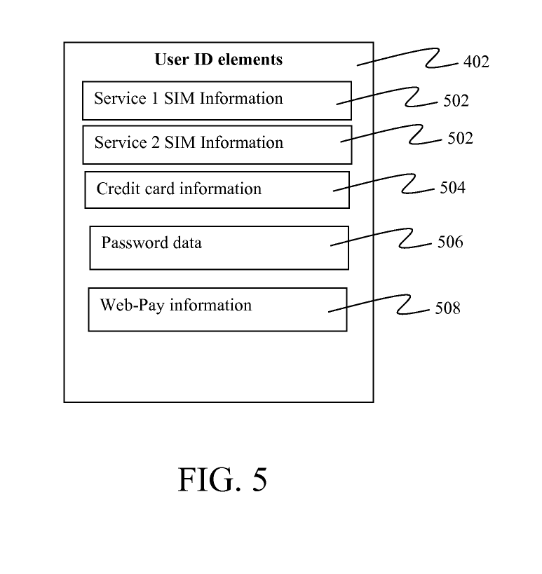

An ID elements storage 402 includes modules shown in FIG. 5 for personal information data comparable to current Subscriber Information Modules (SIM) for one or more services 502, transaction enabling data like passwords 504, scanned credit card info 506, and purchase web or PC data 508 such as PayPal™ data that can be used automatically or on-demand by the host device.

Returning to FIG. 4, the card employing the invention provides Pre-paid modules 404 allowing the capability of the card to have a pre-paid service 406 within memory.

The card additionally has the capability to accept through download from an ATM or web site payments or additional payments service time addition 408 to be deducted as used using the short distance communications module 420 to be described in greater detail subsequently. The pre-paid module capability is provided for additional service suppiers 410.

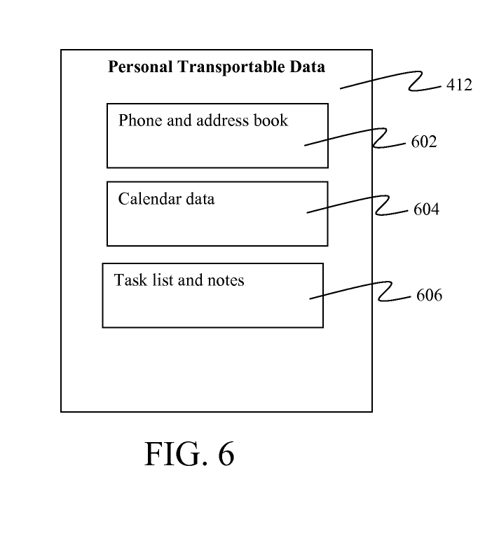

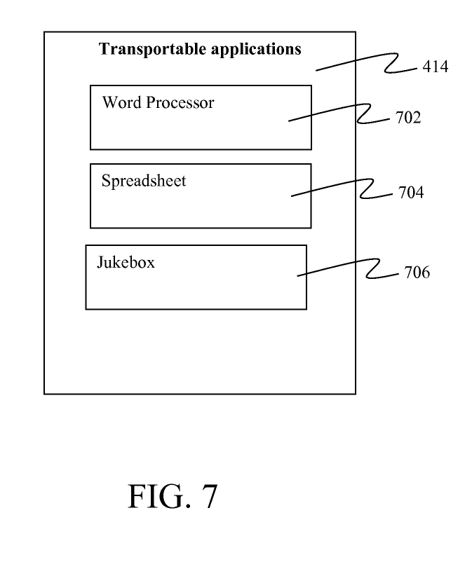

Transportable personal data 412 relevant to the user is also carried by the card. As shown in FIG. 6, such personal data can include phone books 602, calendars 604, task lists and notes 606. Transportable applications 414 and application data 416 are also carried in the card. Typical application comparable to those used in current PDAs such as word processing 702 or spreadsheet 704 programs are provided as shown in FIG. 7. The transportable applications are integrated to work with the transported application data, such as jukebox applications 706 that choose song playlists on the basis of time; on the basis of whose calling, and so on where that data is songs (like MP3) and personal playlists.

To accommodate various devices with which the card is employed, device interface data and operations elements 418 are provided for characterization of, for example, the key strokes that program web access if the MID is a phone, different buttons or dials would be identified if device was an MP3 player or video camera, etc.

To accommodate independent operation of the card, short distance communications 420 such as IR elements or Bluetooth® communications in various exemplary embodiments, are employed to update from a desktop PC any transportable data elements like phonebooks, calendars or other personal or transportable data elements previously described. Additionally, the short distance communications elements are employable for use of the card directly in applications such as credit card substitution. Use of the card in an MID accommodates generation of bar code or other comparable data on an LCD for ID confirmation/transfer.

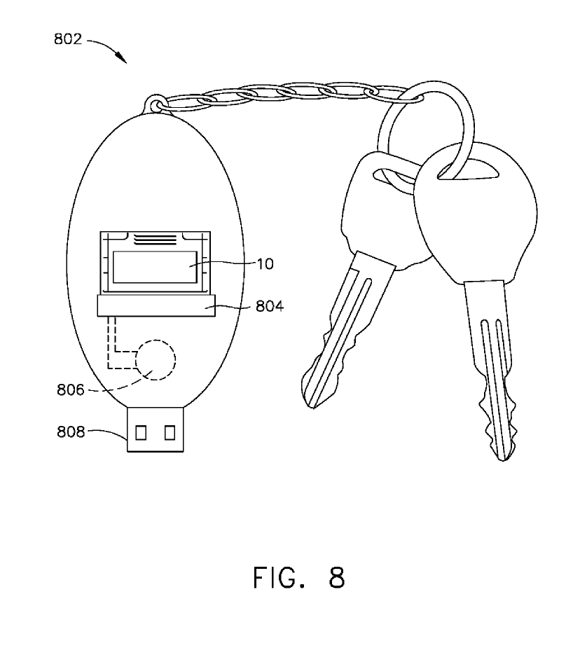

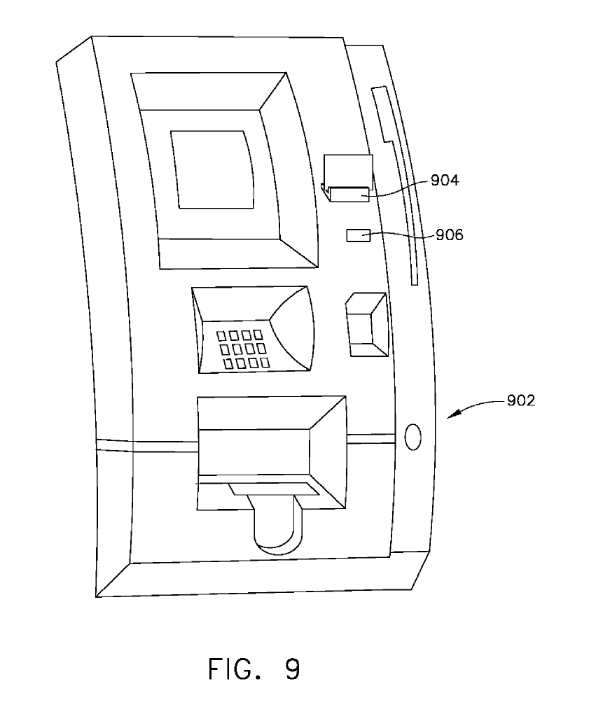

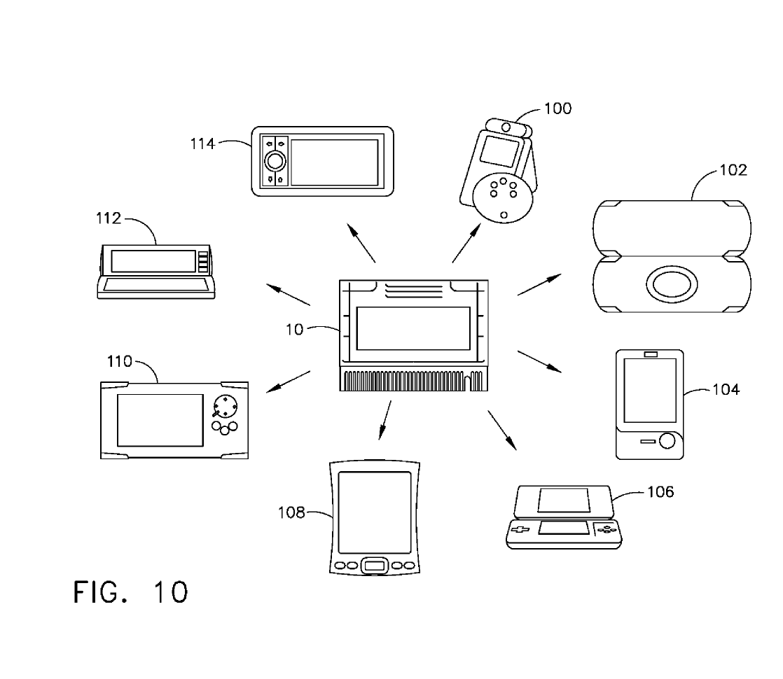

As shown in FIG. 8, a key fob 802, as an exemplary receiver, provides a cradle for the card when not in use in a MID, with a mating connector for the card 804. The fob includes a battery 806 for card power. Use of the internal short range communications device (Bluetooth® or IR) can then be employed for credit card replacement transactions, card update and other independent functions using the card without insertion into a MID. The fob also includes for the embodiment shown a standard USB connector 808 for physical connection of the card to a receiver such as an ATM program server or to any user access via a more suitable input device like a computer keyboard and/or program. Similarly, as shown in FIG. 9, an ATM server 902 is equipped with a comparable cradle or accepting socket 904 for wired connection, or bluetooth, IR or WiFi capabilities in alternative embodiments to then connect to transfer funds/credits to/from the stand-alone mobile card or to conduct the desired transactions. Alternatively or in addition, the ATM server employs as the connector a standard USB port 906 which allows connection of the card through the fob as previously described.

The common architecture of the miniaturized form factor card according to the present invention allows use in a wide variety of mobile information devices such as an MP3 player 100, Sony PSP portable game console 102, mobile phone 104, text messaging device 106, smart phone 108, Global Positioning System (GPS) 110, Personal Digital Assistant (PDA) phone with keyboard 112, and PDA 114 as shown in FIG. 10. The incorporation of communications functions into these devices without requiring design specific circuitry allows rapid incorporation of the communications functions into the innovative designs.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An identification and communications system comprising:
an insertable miniaturized form factor card received in a mobile information device and incorporating
means for RF transmission and reception and a wireless modem
means for interfacing with user interface components of the mobile information device to interconnect digital functions of the wireless modem and means for RF transmission and reception through the interface;
means for user identification and user specific data storage.

2. A system as defined in claim 1 wherein the user identification data includes subscriber information for at least one service.

3. A system as defined in claim 1 wherein the user identification data includes user financial data.

4. A system as defined in claim 1 wherein the user specific data storage includes personal phonebook data.

5. A system as defined in claim 1 wherein the insertable miniaturized form factor card further includes means for short distance communication.

6. A system as define in claim 1 wherein the insertable miniaturized form factor card further includes a prepaid service module.

7. An identification and communications system comprising:
an insertable miniaturized form factor card received in a mobile information device and incorporating
means for RF transmission and reception and a wireless modem
means for interfacing with user interface components of the mobile information device to interconnect digital functions of the wireless modem and means for RF transmission and reception through the interface;
means for user identification including subscriber information for at least one service and user financial data;
means for user specific data storage including personal phonebook data; and
means for short distance communication.

8. An identification and communications system comprising:
an insertable miniaturized form factor card removably received in a mobile information device and incorporating
means for RF transmission and reception and a wireless modem
means for interfacing with user interface components of the mobile information device to interconnect digital functions of the wireless modem and means for RF transmission and reception through the interface;
means for user identification and user specific data storage; and
means for short distance communication;
a receiver independent of the mobile information device having
a connector for attachment to the interfacing means on the card when removed form the mobile information device;
a battery connected to the card through the connector for providing power to the card.

9. An identification and communication system as defined in claim 8 wherein the battery power to the card provides power to the means for short distance communication.

10. An identification and communication system as defined in claim 8 wherein the receiver further incorporates a second connector for external attachment of the card to a second device.
